(19) United States
(12) Patent Application Publication
(10) Pub. No.: US 2008/0158123 A1
(43) Pub. Date: Jul. 3, 2008

(54) Active Matrix for a Liquid Crystal Display Device

(75) Inventors: Hugues Lebrun, Coublevie (FR); Thierry Kretz, Saint Jean De Moirans (FR)

Correspondence Address: OBLON, SPIVAK, MCCLELLAND MAIER & NEUSTADT, P.C., 1940 DUKE STREET, ALEXANDRIA, VA, 22314, US

(73) Assignee: THALES, Neuilly-Sur-Seine (FR)

(21) Appl. No.: 11/997,679

(22) PCT Filed: Aug. 1, 2006
(86) PCT No.: PCT/EP2006/064913

§ 371 Date: Feb. 1, 2008

(30) Foreign Application Priority Data
Aug. 2, 2005 (FR) 05 08259

(51) Int. Cl. G09G 3/36

(52) U.S. Cl. 345/90; 345/92; 345/91

(57) ABSTRACT

An active matrix for a liquid crystal display device including pixel electrodes arranged in a crossed network of rows and columns. Associated with each pixel electrode, an electrode control device is provided, including a first switching element connected between the pixel electrode and an associated column, a control electrode of the switching element being connected to an associated row. The control device includes an initialization circuit for the pixel electrode including a second switching element, connected to the pixel electrode, and a control electrode of which is connected to a preceding row of the network. Such an active matrix may be applicable to active matrix bistable nematic displays.

The present invention relates to an active matrix for liquid crystal display devices.

The invention applies in particular to bistable nematic liquid crystal display devices, normally called BiNem® devices. In the description that follows, we will use the term bistable nematic display. Bistable nematic displays are used in various applications, and more particularly in so-called roaming applications. Just a few examples of these include portable telephones or pocket computers such as personal digital assistants (PDA), or even e-books.

These bistable nematic displays have the particularly interesting property of not requiring image refresh, which is very favourable for all these roaming applications, for which consumption must be kept to a minimum. They offer a high quality image independent of the number of rows.

These bistable nematic displays normally comprise a so-called passive matrix: each pixel is controlled directly by a row signal and a column signal. The drawback of passive matrices is that the pixel of a column “sees” all the signals applied to each of the pixels of the column, during the time for which an image is displayed. This makes the use of this technology for large screens problematic. Furthermore, switching is slow, which makes this technology unusable for video applications.

Thus, these passive matrix displays are more particularly suited to applications where the image changes little or slowly, and to small sizes, typically for e-book type applications.

For these various reasons, efforts have been made to use active matrices with such displays. The term “active matrix” is used to mean a matrix structure of pixel electrodes, in which the addressing involves a switching device associated with each pixel electrode. When a pixel is not addressed, the associated switching device isolates the pixel electrode from the row and column signals (apart from the problems of coupling by stray capacitances).

The switching device can be a diode or a transistor. It is advantageously a standard TFT (Thin Film Transistor) type transistor, which uses a thin film of amorphic silicon (a-Si). In practice, these transistors have the advantage over polycrystalline silicon transistors of having a zero or very low leakage current, which is a very important characteristic when it comes to maintaining the information on the TN type pixels.

The active matrix comprising the pixel electrodes, the switching devices and the row and column conductors is produced on a first substrate.

The display comprises, in addition to the active matrix, a second substrate which forms the other pixel electrode, common to all the pixels and also called counter-electrode. The second substrate is disposed so that a cavity is formed between the top of the active matrix and the second substrate. The cavity is filled with liquid crystal with a composition and an orientation of the molecules that is dependent on the planned technology. The pixel electrode and the counter-electrode then form the two armatures of the pixel capacitance, and the bistable material that is used to store the information is between the two armatures.

A liquid crystal display of the active matrix bistable nematic type is described in the French patent application entitled: “Procédé et dispositif perfectionnés d'affichage à cristal liquide nématique bistable” (Sophisticated bistable nematic liquid crystal display method and device), registered under No. 02 14806, and filed by Nemoptic. An AMLCD (Active Matrix Liquid Crystal Display) type (screen) display is obtained.

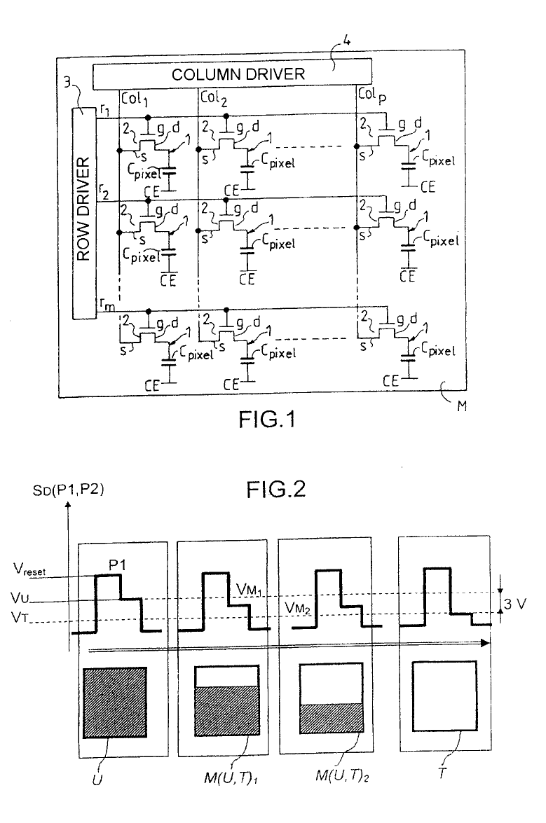

An active matrix structure for bistable nematic display as described in the abovementioned application is diagrammatically illustrated in FIG. 1.

The structure M of the active matrix normally comprises m*p pairs (pixel electrode 1, transistor 2) arranged in a network of m rows r₁, r₂, . . . rₘ, and p columns col₁, col₂, . . . colₚ.

The transistor 2 associated with each pixel electrode 1 allows a corresponding pixel of the screen to be addressed individually by a row conductor and a column conductor.

In the description below, the terms “row” and “column” are used to mean the conductor, in the electrical sense, or the row or the column in the matrix arrangement sense.

The transistor 2 associated with each electrode 1 acts as a switching element. When it is switched to the on state, it allows a determined voltage level to be applied to the pixel electrode, enabling a corresponding grey level to be displayed on the screen pixel. When it is switched to the off or blocked state, it isolates the pixel electrode from the rest of the matrix (apart from couplings by stray capacitances). The transistor comprises two conduction electrodes, called drain d and source s, and a gate electrode g, via which the “on” or “off” state of the transistor is controlled.

More specifically, the transistor is normally connected in the matrix structure as follows: a conduction electrode, for example the drain d, is connected to the pixel electrode. The gate g of the transistor is controlled by the row select signal applied to the associated row. The other conduction electrode of the transistor, in the example the source s, is connected to the associated column.

Thus, the gates of all the transistors of one and the same row are all connected to that row, whereas the sources of all the transistors of one and the same column are all connected to that column. When a transistor is set to “on”, it switches the voltage applied by the column associated with its source to the drain d: thus, the pixel electrode 1 is charged to a voltage level corresponding to a video data item (grey level) to be displayed.

The pixel electrodes 1 are each controlled, via their associated transistor 2, by peripheral addressing circuits. These addressing circuits typically comprise a row control circuit 3, more simply called row driver in the description that follows, and a column control circuit 4, more simply called column driver in the description that follows. The row control circuit 3 applies voltage levels successively to the rows, in order to select them sequentially over a frame time. On each row time, the control circuit 4 of the columns applies appropriate voltage levels to the columns, in order to display a given grey level on each pixel of the selected row.

Controlling the pixels of a bistable nematic screen presupposes the use of high voltages, if the switching between the two stable states of the pixel is to be rapid. These two stable states correspond to two different textures, a uniform texture and a twisted texture. They result from a shrewd composition of the liquid crystal associated with orientation layers of the molecules that are different on each side of the substrates (or wafers) that form the cavity filled with liquid crystal.

The uniform texture is defined by a low twist angle, close to 0°, in the thickness of the pixel. The twisted texture is defined by a high twist angle close to 180° in the thickness of the pixel.

These two textures are characterized by the existence of two molecule anchoring points, one anchoring on each of the wafers forming the cavity containing the liquid crystal, each being coated to this end with an appropriate different orientation layer. One anchoring point is very strong, and little affected by the application of an electrical field. The other anchoring point is weak. This weak anchoring can be broken when a strong electrical field is applied. Thus, the only way to switch from one stable state to another is to apply energy in the form of an electrical pulse, the effect of which is to break the weak anchoring point. Then, depending on the shape of the pulse, the molecules are organized in the thickness of the pixel in one of the two stable states. More comprehensive details on this technology and its principles can be found in the following publications by Ivan N. Dozov et al., “Fast bistable nematic display from coupled surface anchoring breaking”, SPIE Proceedings Vol. 3015, pp. 61-69 (0-8194-2426-9, 214 pages Published 1997) and “Ultra low power bright reflective displays using Binem® technology fabricated by standard manufacturing equipment”, SID Symposium Digest of Technical Papers—May 2002—Volume 33, Issue 1, pp. 30-33.

Thus, the shape of the electrical field applied to the terminals of the pixel provides a way of choosing one or other of the two textures after a step for breaking the anchoring with a high electrical field value, equivalent to a texture “reset” phase. This reset phase is characterized by a determined breaking voltage level, and an application time.

In the subsequent writing phase, one or the other texture is obtained according to the shape of the electrical pulse applied. In practice, the switching to one or the other stable state can be obtained by the shape of the falling edge of the electrical pulse.
the uniform texture U can be obtained by a switch with slow falling edge, for example by a staged shape or by an analogue falling voltage ramp from the breaking voltage level, which favours an elastic relaxation behaviour. This elastic relaxation process drives the molecules to arrange themselves in parallel with no twist angle, leading to a uniform texture U. The pixel appears black on the display.
the twisted texture T can be obtained by a switch with steep falling edge, from the breaking voltage level, which favours a dynamic process of modification of the orientation of the molecules, known as “backflow”. The strong hydrodynamic flux of the liquid crystal molecules of the pixel results in a break in the weak anchoring of the molecules and an organization of the molecules with a twist angle of around 180°. The pixel appears white on the display.

According to the state of the art, it is also known how to display a grey level, corresponding to a mixed texture, by a switch with intermediate edge, which leads to a coexistence of both textures in the thickness of the pixel, in a proportion that is variable according to the grey level to be displayed.

A display control signal SD(P1,P2) of a grey level on a bistable nematic display is illustrated in FIG. 2. Such a signal is in particular described in the abovementioned French patent application (FR 02 14806). This is a signal with two stages, P1 and P2, applied to the columns of the matrix during each row time. The first stage P1 corresponds to the anchoring breaking phase. It is characterized by a duration τ1 and a determined voltage level VP1. This voltage level is in practice chosen to be greater than or equal to a breaking voltage defined for the technology, according to the application time τ1.

The second stage P2 corresponds to the display phase (or writing phase) of the new texture. It is characterized by a duration τ2 and a voltage level VP2 less than the anchoring breaking voltage VP1. Thus, on each column, the shape of the signal SC is dependent on the data to be displayed.

The sum τ1 plus τ2 gives the row time of the display, namely the time needed to display the new display data on the pixels of a selected row of the matrix.

The step difference (or height) between the first stage P1 and the second stage P2 depends on the texture that is to be obtained.

The slow falling edge needed to obtain the uniform texture U is thus obtained by choosing a second, lower stage P2, but not too distant from the first stage.

The steep falling edge needed to obtain the twisted texture T is obtained by choosing a second stage P2, further away and therefore lower than in the previous case.

VP1 is used to denote the voltage level of the first stage P1 and VP2 the variable voltage level of the second stage P2 of duration τ2, dependent on the texture to be obtained. VP2 is equal to VU<VP1, to control a uniform texture U (black display); VP2 is equal to VT<Vu<VP1, to control a twisted texture T (white display); and VP2 is equal to an intermediate value VMᵢ between VT and VU (VT<VMᵢ<Vu<VP1) to control a mixed texture M(U,T)ᵢ in which the two textures U and T coexist (grey level display).

The voltage VP2 can thus take any value between the values Vu and VT, which are characteristics of the technology. In the example illustrated, for VP2=VM₁, there appears a portion of twisted texture T, in the uniform texture U: the result is a mixed texture M(U,T)₁, corresponding to a determined grey level. For VP2=VM₂<VM₁, the portion of twisted texture T becomes greater: the result is a mixed texture M(U,T)₂, corresponding to a determined grey level, lighter than the one before.

Thus, the intermediate grey levels are obtained by varying the voltage level VP2 of the second stage between the extreme values VU and VT. In a practical example, for a given technology of the state of the art, a variation range of approximately 3 volts between VU and VT (VU−VT≈3 volts) is thus available. The nearer the voltage level of the stage P2 approaches VT, the greater is the “backflow” effect. The double arrow from left to right in FIG. 2 illustrates the ascending direction of this effect according to the voltage of the second stage.

In a practical example, the level of the anchoring breaking voltage VP1 is approximately 15 to 18 volts for fairly long row times.

In the case of an active matrix, these voltages must be applied to the pixel electrode, via the switching transistor.

The display control signal SD(P1,P2) that has just been described in relation to FIG. 2 is applied to the columns, while a row select signal is applied in turn to each row of the matrix, during the row time. The display control signal has two separate and successive signal components: a reset signal and a video signal. The reset signal corresponds to the initial, anchoring breaking phase. The video signal corresponds to a new texture writing or programming phase. These two signals have different voltage levels.

In practice, the procedure for addressing a row of the matrix in order to display new data is as follows: the row is selected by applying a select signal which has the shape of a voltage pulse, during the row time. This pulse is in fact applied to the gate g of each of the transistors of the row (FIG. 1). This pulse has a sufficiently high voltage level to switch each of the transistors 2 of the row to the “on” state.

A display control signal is applied to each of the columns of the matrix, and therefore to the source s of the transistors.

The gate voltage applied to the transistors of the selected row must be at least equal to the voltage applied to the columns plus the threshold voltage Vth of the transistors (i.e. the minimum voltage applied between gate and drain, or gate and source, for the transistor to be conductive), in order for each transistor of the selected row to switch, virtually without losses, the display signal SC on the associated pixel electrode.

The active matrices according to the state of the art have been more particularly developed for TN “Twisted Nematics” or IPS “In Play Switching” type liquid crystal screens, with standard row and column drivers designed to support the control voltage levels. These row or column drivers are preferably incorporated in the active matrix. They can be produced on an external circuit. They receive the analogue power supplies needed to display the video data that they receive. The row driver is responsible for scanning the rows, sequentially, and the column driver is responsible, for each line, for applying to the columns voltage levels to be applied to the pixel electrode to display a corresponding data item (grey level) on each pixel of the row.

In the standard TN case, the high voltage column drivers are designed to deliver 13 volts, enabling approximately 6 volts rms to be obtained on the liquid crystal (positive and negative half-waves). For a standard IPS active matrix, the maximum voltage reaches 16.5 volts. The standard row drivers are capable of outputting voltage levels from −10 volts to 30 volts, for example.

Thus, for relatively long row times, the range of voltages needed to control the bistable nematic displays is compatible with the drivers of the standard active matrices of the state of the art, TN or IPS.

In the invention, interest is focussed on active matrix bistable nematic displays, for video applications in particular. For these video applications, the row time needs to be shorter, requiring the pixel switching time to be reduced. The issue is therefore how to make the reset phase as short as possible. Now, the shorter the anchoring breaking phase is, the higher the breaking voltage needed needs to be. This is in particular explained in the abovementioned publication (see section 3.4 and FIG. 5 in particular) and in a more recent publication by Ivan Dozov et al. “Recent improvements of bistable nematic displays switch by anchoring breaking”, SID Symposium Digest 32, 224 (2001). To obtain a switching time compatible with a row time of 50 microseconds, or less (for video applications, the row times need to be 40 microseconds or less), the breaking voltage is then greater than 20 volts with the current bistable nematic displays.

A problem which then arises in the use of a standard active matrix, in conjunction with bistable nematic displays, is that there is no longer compatibility between the range of voltages needed to control these displays and the standard technology of the column drivers of the active matrices.

In practice, it has been seen how, in the state of the art, the breaking voltage level is applied to the columns of the matrix by the column driver 4 (FIG. 1). It has also been seen how the row drivers of the state of the art are designed to apply gate voltage levels with an amplitude that can range up to 40 volts. However, the column drivers cannot apply voltages greater than 16.5 volts in the best case (IPS standard) to the drains (or sources) of the transistors of the matrix. It is therefore not possible to command voltages greater than 13 volts (TN drivers) or 16.5 volts (IPS drivers) on the columns of the matrix. These levels are insufficient to allow for anchoring breaking on a row time that is short enough to be compatible with video applications.

Thus, even if the TFT transistors associated with the pixel electrodes are capable of supporting and switching a voltage greater than 20 volts, it is not possible to apply such voltages using the standard drivers of the state of the art.

If the voltages to be applied to the gates of the transistors, and the range [VU, VT] of the voltage levels of the video signal to be applied, i.e. between 10 and 13 volts in practice, respectively corresponding to the twisted texture T and the uniform texture U, are indeed included in the standard specifications of the drivers of these matrices, the same does not apply for the initialization component (stage P1) of the display control signal SD(P1,P2) applied to the columns: it is not in fact possible to apply a breaking voltage of 20 volts and above by means of standard column drivers of the state of the art.

Now, developing new, specific drivers is always a lengthy and expensive operation.

One object of the invention is to solve this technical problem.

One object of the invention is to offer an active matrix bistable nematic display structure that can be used with standard drivers (integrated or external) to apply high voltage levels to the pixel electrodes.

One object of the invention is to propose such an active matrix at low cost.

One object of the invention is to obtain an active matrix for a bistable nematic display device, essentially by modifying the drawings of the masks used to fabricate a standard active matrix for TN or IPS displays.

One idea on which the invention is based is to start from a standard active matrix, modify its structure so as to be able to use standard drivers and apply the control voltage levels needed on the pixel electrodes, without degrading either the reliability of the matrix or that of the drivers.

According to the invention, provision is made for the switching device associated with each pixel electrode to include another switching element, for example another transistor, the function of which is to handle the breaking of the anchoring point of the pixel. Thus, in the switching device, the reset function and the writing function of a new texture are separated. This other switching element can be controlled by the row driver, which supports high voltages of around 40 volts, and connected to a specific power supply bus to switch a breaking voltage of around 20 volts or above. This breaking voltage is applied by the specific power supply bus and no longer by the column driver which is then used exclusively to control the voltage levels corresponding to the video to be displayed, as for the standard TN or IPS matrices.

The specific power supply bus can be produced by conductors that are added to the structure of the matrix, on the conductive layer levels, or by functional conductive layers already provided in the matrix, but the function of which can be diverted, for the purposes of applying the breaking voltage level thereto. These are typically conductive functional layers provided in the active matrix structures as storage capacitance. These layers can be diverted from their original function, because the pixels of the bistable nematic displays do not require storage capacitance to maintain the voltage level on the pixel electrode. In practice, once the new texture is “written” in the pixel, it remains there indefinitely, as long as an anchoring point is not broken. It is also possible to use the “light shield” type light screen normally used to enhance the open aperture ratio OAR. In practice, this screen is normally conductive, to enhance the storage capacitance. Thus, it is possible to divert functional layers provided in the TN or IPS active matrices of the state of the art to produce a specific power supply bus, for the breaking voltage, and for little development cost.

The invention therefore concerns an active matrix for a liquid crystal display device, comprising pixel electrodes arranged in a crossed network of rows and columns, and, associated with each pixel electrode, an electronic control device comprising a first switching element connected between said pixel electrode and an associated column, a control electrode of said first switching element being connected to an associated row, wherein said control device comprises a circuit for initializing said pixel electrode comprising a reset bus and a second switching element connected between said pixel electrode and said reset bus, a control electrode of which is connected to a preceding row of the network.

The invention applies to liquid crystal displays comprising such an active matrix, and in particular a bistable nematic type display.

Other advantages and characteristics of the invention will become more clearly apparent from reading the description of the invention that follows, given by way of indication and in a non-limiting way, and with reference to the appended drawings, in which:

FIG. 1, already described, represents an active matrix structure for bistable nematic display, according to the state of the art;

FIG. 2, already described, illustrates the display control of a pixel of a bistable nematic display;

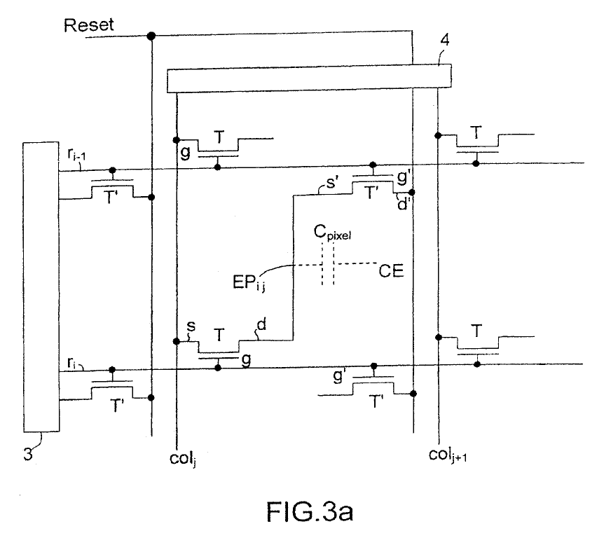

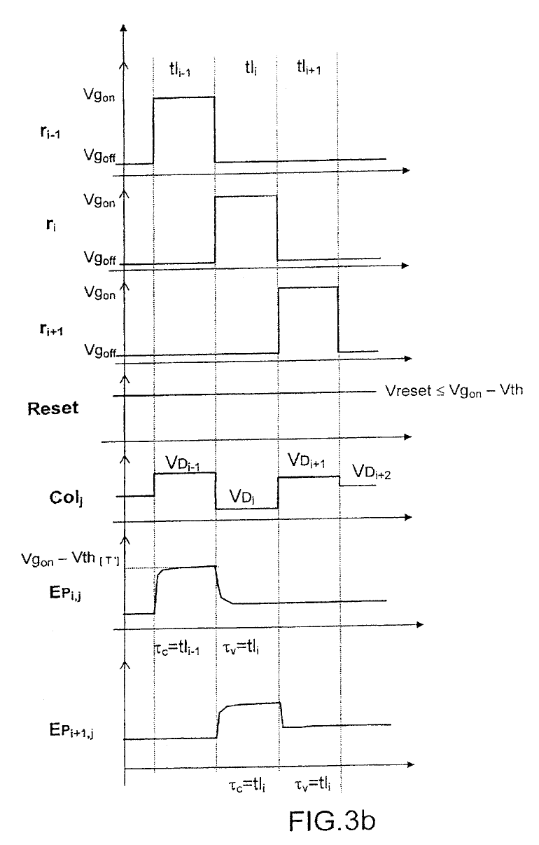

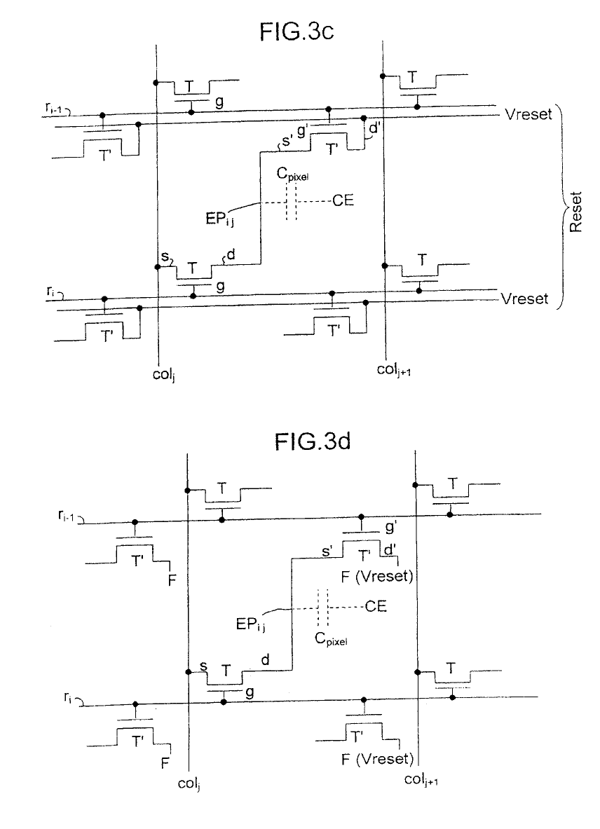

FIG. 3a illustrates a first embodiment of an active matrix according to the invention, with an initialization phase for each row of the matrix, corresponding to the breaking of the anchoring, carried out on the addressing time of the preceding row;

FIG. 3b illustrates electrical signal shapes on the various conductors of the matrix of FIG. 3a;

FIGS. 3c and 3d each represent a variant embodiment of an active matrix according to the invention;

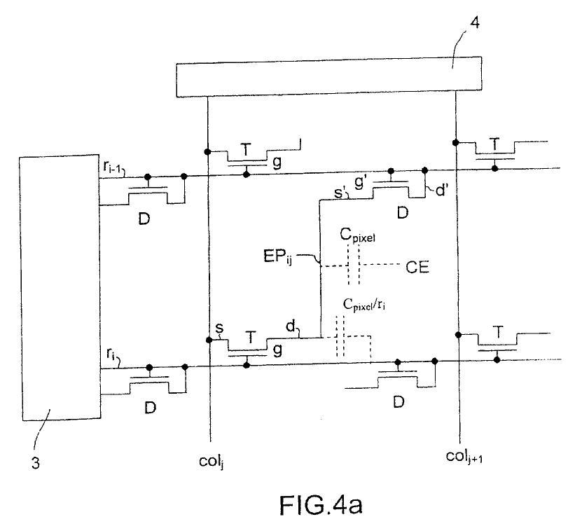

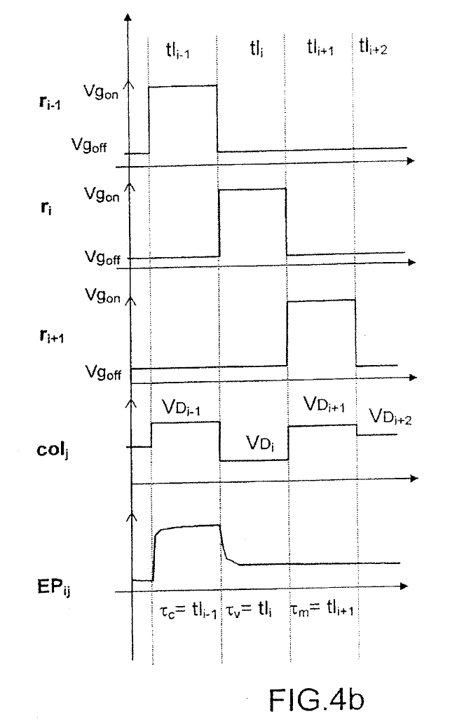

FIG. 4a illustrates another embodiment of an active matrix according to the invention;

FIG. 4b represents corresponding electrical signals on the rows or columns of the matrix;

FIG. 5 illustrates an active matrix of the state of the art, comprising a storage capacitance bus under each row of pixel electrodes, and which can be used in the invention;

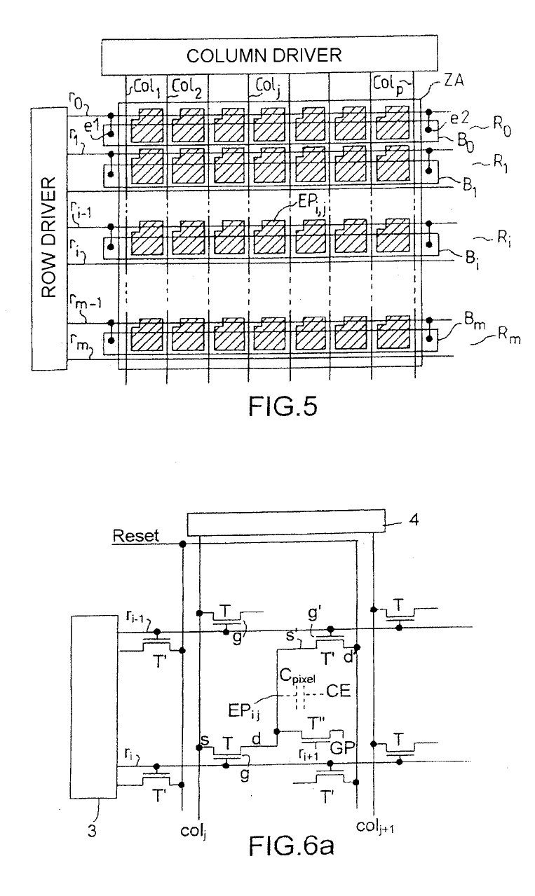

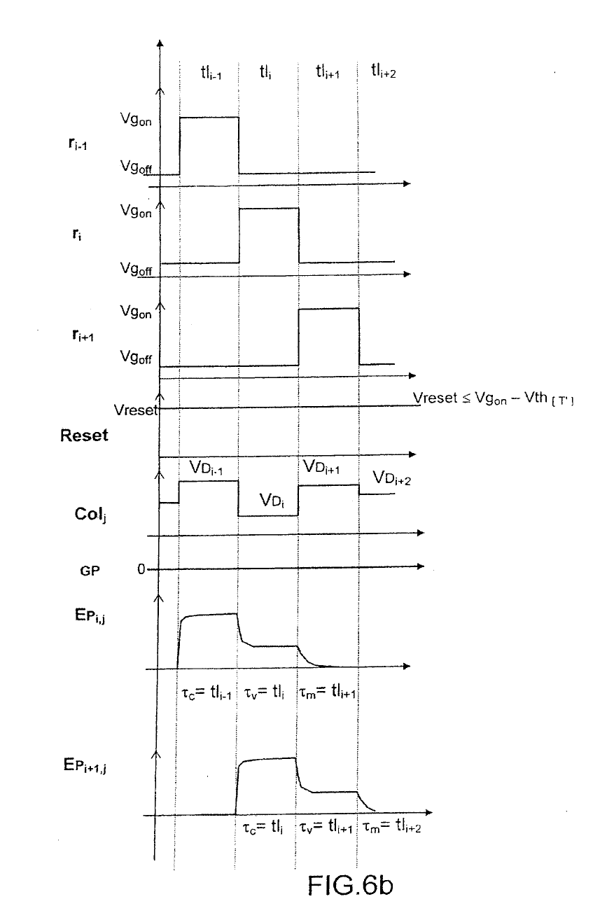

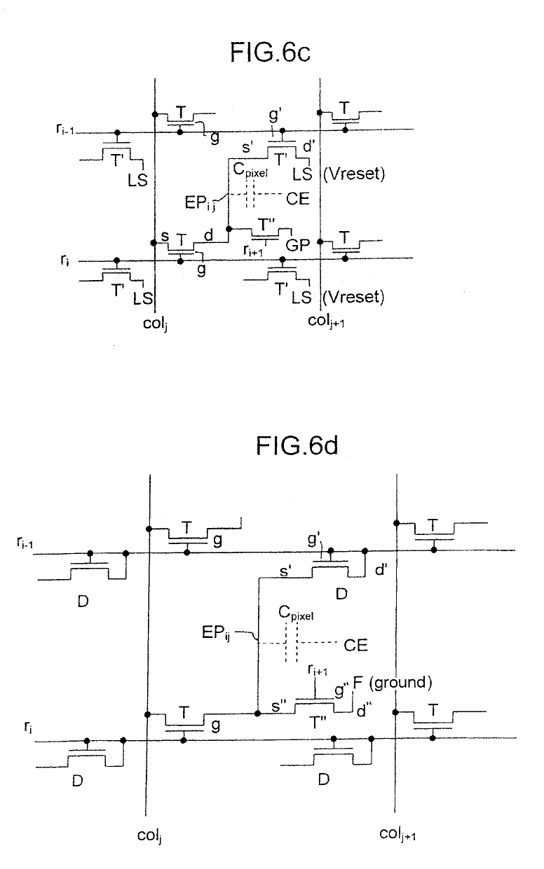

FIG. 6a illustrates a first embodiment of a refinement of an active matrix according to the invention;

FIG. 6b represents corresponding electrical signals on the rows and columns of the matrix;

FIGS. 6c and 6d each illustrate a variant embodiment of the refinement;

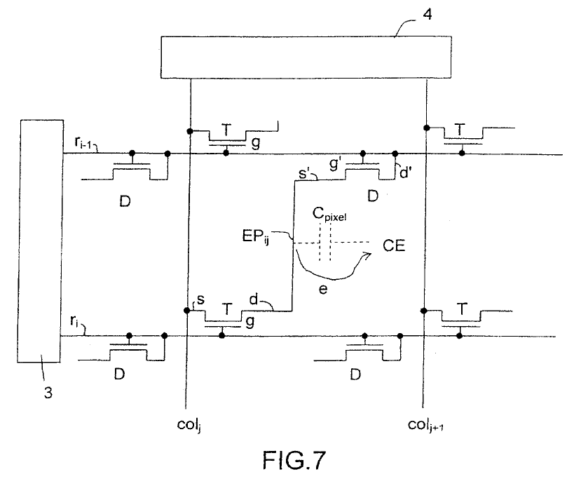

FIG. 7 illustrates another embodiment of the refinement of an active matrix according to the invention; and

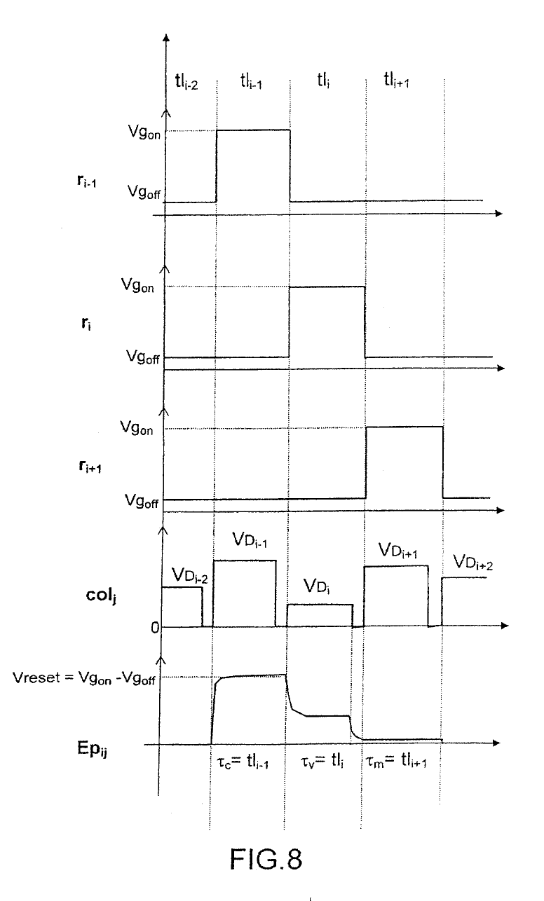

FIG. 8 illustrates a variant of the method of controlling a matrix structure according to FIG. 3a.

FIG. 3a illustrates a first example of an active matrix structure with standard transistors according to the invention, capable of allowing very high voltage levels to be applied to the pixel electrodes, without risking the breakdown of the transistors used. Such a matrix structure used in a bistable nematic display then allows the display to be used in video applications, with row times less than 40 microseconds, which offers interesting prospects of opening up the market for these displays.

A pixel electrode EP_{i,j}, associated in the matrix with the row rᵢ and the column Colⱼ, comprises an associated control device. This device normally comprises a switching element T connected between the column Colⱼ and the pixel electrode EP_{i,j}. The control electrode g of this switching element T is connected to the row rᵢ. The switching element is typically a transistor, one conduction electrode of which, the source s for example, is connected to the column, and the other conduction electrode of which, the drain d for example, is connected to the pixel electrode.

According to the invention, the control device of each pixel electrode also comprises a circuit for initializing the pixel electrode on the preceding row time.

In the embodiment shown, this initialization circuit is a transistor type switching element, T′.

This initialization transistor T′ is connected between a conductor linked to a specific Reset power supply bus, and the pixel electrode. For example, the source s′ of the transistor T′ is connected to the pixel electrode EP_{i,j} and the drain d′ of the transistor T′ is connected to the Reset bus. The gate g′ of this initialization transistor is connected to a preceding row, rᵢ₋₁ in the example.

If a liquid crystal display using such a matrix is considered, a corresponding pixel is formed between the pixel electrode EP_{i,j}, and a counter-electrode CE.

As illustrated in FIG. 3b, the selection of a row, for example the row rᵢ, entails having the row driver 3 apply a voltage level Vgₒₙ to this row. The transistors, the gate of which is connected to this row, are then in the “on” state, equivalent to a short circuit. Deselecting this row entails having a voltage level Vg_{off} applied to this row. The transistors of a deselected row are then in the “off” state, equivalent to an open circuit.

It will thus be understood that the transistors T′ associated with the pixel electrodes EP_{i,j} of the row rᵢ and the gates of which are connected to the preceding row rᵢ₋₁, are set to the “on” state on the preceding row time tlᵢ₋₁, that is when the row rᵢ₋₁ is selected. They are in the “off” state otherwise. In particular, they are in the “off” state on the row time tlᵢ. The transistors T are themselves in the “on” state on the row time tlᵢ, and in the “off” state on the other row times.

The Reset bus is brought to a continuous voltage level Vreset greater than or equal to the anchoring breaking voltage of the liquid crystal molecules. When the transistor T′ switches to the “on” state, it transfers the voltage level Vreset to the pixel electrode EP_{i,j} on the row time tlᵢ₋₁, at a level of Vgₒₙ-Vth which must be greater than the breaking voltage.

When the row rᵢ is then selected, on the row time tlᵢ, the transistor T′ switches to the “off” state (row rᵢ₋₁ deselected) and the transistor T switches to the “on” state. The pixel electrode EP_{i,j} is charged by the transistor T to the voltage level VDᵢ applied in the same time tlᵢ to the associated column Colⱼ.

The term “row time” is used to mean the addressing time of a row, during which the row control circuit (row driver) applies a select signal to that row, the effect of which is to switch all the switching elements T of that row on. All the other rows are deselected during this row time.

Thus, as represented in FIG. 3b, the row driver applies, on the row time tlᵢ of the row rᵢ, a voltage level Vgₒₙ which switches all the transistors T of that row on. On the other rows, the row driver applies a voltage level Vg_{off}, so that all the transistors are “off”. Vg_{off} is in practice less than the threshold voltage of the transistor T. It is possible to have Vg_{off}=0 volts. The transistor T then switches the voltage VDᵢ applied to its source, by the associated column Colⱼ. This switching is accomplished without losses because VDᵢ is at most equal to the voltage level for a uniform texture, or 13 volts in the state of the art, while the gate voltage Vgₒₙ is far greater, around 20 volts and above.

The pixel electrode EP_{i,j} connected to a transistor T of the selected row rᵢ is therefore charged roughly to the voltage level VDᵢ which is applied to the corresponding column Colⱼ on the row time tlᵢ. This voltage level typically corresponds to the data item to be displayed.

On the pixel electrode EP_{i,j}, there is a signal shape with two stages spread over the row times tlᵢ₋₁ and tlᵢ. The first stage corresponds to an anchoring breaking phase τ_{c}, and the second stage to a new video data item writing phase τᵥ.

Such a matrix according to the invention controlled as described in relation to FIG. 3b, and used in a bistable nematic display, therefore allows for the pixels to be controlled appropriately to display the different grey levels, with a switching that is fast enough to allow video applications to be considered, because the breaking phase τ_{c} takes place on a preceding row time, and the voltage levels applied are compatible with the standard TN or IPS technology.

In fact, it has been seen how, in relation to the description of a bistable nematic display, the initialization voltage Vreset was approximately 20 volts or greater than 20 volts, for row times compatible with video applications. In the invention as illustrated in FIG. 3a, this voltage is applied by a specific bus, directly to the drain of the transistor T′ of the matrix, while the gate g′ controlled by the row driver receives a voltage Vgₒₙ greater than the voltage Vreset by at least the threshold voltage Vth of the transistor T′. The threshold voltage Vgₒₙ remains less than 30 volts: it is therefore compatible with the gate control voltage range of the standard row drivers.

The video voltage levels applied by the column driver to the sources or drains of the transistors T vary between 13 volts, to obtain a uniform texture U, and 10 volts, to obtain a twisted texture T. These voltage levels are within the range of control voltages supplied by the standard column drivers.

An active matrix as illustrated in FIG. 3a, used with standard row and column drivers, whether incorporated in the matrix or not, in a bistable nematic display, is thus capable of allowing for anchoring breaking and the display of the new video data for each of the pixels of a row rᵢ, on two separate row times: anchoring breaking on the preceding row time tlᵢ₋₁ and display of the new video data item on the row time tlᵢ.

The control device of each pixel electrode comprising a transistor T and an initialization circuit T′ according to the invention can thus be used to simply obtain a two-stage signal shape on the pixel electrode, as illustrated in FIG. 3b for the pixel electrodes EP_{i,j} and EP_{i+1,j}.

This signal is compatible with the control of the pixels of a bistable nematic display. This is obtained by using a standard active matrix, with standard row and column drivers, for TN or IPS displays, simply by adding a transistor to the matrix. This is obtained simply by modifying the drawings of the masks, without having to modify the steps of the standard fabrication method.

For a bistable nematic display, adding a transistor for each pixel is not prejudicial in terms of OAR, because the ultra-portable devices that use such displays normally operate in reflective mode.

Moreover, the transistors T and T′ are each used in normal voltage ranges.

Thus, separating the anchoring breaking and video display functions by different switching means, activated on different row times, provides a way of applying voltage levels that are compatible with the technology, and with video applications.

In the example represented in FIG. 3a, the specific Reset power supply bus, which directs the initialization voltage Vreset to the drains or sources of the initialization transistors of the matrix, comprises a plurality of conductors disposed parallel to the columns. In practice, these conductors are provided on the same level as the columns of the matrix, or on a separate level.

It is possible in a similar way to provide for the conductors of the Reset power supply bus to be disposed parallel to the rows of the matrix. This is the variant represented in FIG. 3c. In this respect, it will be noted that there are, in the state of the art, matrices that comprise, for each pixel, a column, an addressing row and a storage capacitance row. It is then easy to use these matrices of the state of the art by changing the function of these storage rows to a function for bringing an initialization voltage Vreset to the drains (or sources) of the initialization transistors T′, by providing appropriate connections between these rows and these drains (or sources).

In another variant embodiment of a matrix according to the invention, as illustrated in FIG. 3d, the Reset power supply bus is formed by a conductive functional layer F of a standard matrix, such as the buried ground plane normally used to form a storage capacitance with each pixel electrode, in the standard TN matrices in particular. Such a functional layer is formed on a layer separated from the pixel electrodes by at least one insulating layer, to form a storage capacitance in parallel with the pixel capacitance Cpixel.

In fact, as has already been explained, such a storage capacitance has no use in bistable nematic displays, since the molecules, once oriented according to the type of texture, uniform or twisted, remain in this state indefinitely as long as the weak anchoring is not broken.

This functional layer can even be a “Light Shield” type layer, that is, a screen that is used commonly in standard TN matrices in particular, to mask the light leakages due to the field lines induced by the structure. This is normally a conductive and opaque layer, of titanium in grid form, and which can be either disposed under the active matrix (that is, under the transistors) or between the level of the rows/columns (forming the drains/sources of the transistors) and the pixel electrodes. This conductive layer is normally formed on a level separated from the pixel electrodes by at least one insulating layer and is thus used in these structures as storage capacitance for each pixel electrode. For the same reasons as previously, it is therefore possible to use this layer, without any difficulty, as a bus for bringing the initialization voltage Vreset to the drain (or the source) of each initialization transistor T′.

Another embodiment of an initialization circuit according to the invention is represented in FIG. 4a. The initialization circuit of the control device of a pixel electrode of a row rᵢ then comprises a diode D connected between the pixel electrode EP_{i,j} and the preceding row rᵢ₋₁.

The diode D can typically be obtained by a transistor, the drain d′ (or the source) and the gate g′ of which are connected together, to the preceding row rᵢ₋₁. The other conduction electrode of the transistor, the source s′ in the example, is linked to the pixel electrode EP_{i,j}.

FIG. 4b shows the shape of the signal that can be obtained on the pixel electrode EPᵢⱼ, according to the signals applied to the rows and columns of the matrix during the different row times tlᵢ₋₁ tlᵢ, tlᵢ₊₁, etc. It is roughly the same as that illustrated in FIG. 3b.

FIG. 5 illustrates an exemplary active matrix described in the French patent application entitled “Structure de matrice active pour écran de visualisation et écran comportant une telle matrice” (Active matrix structure for display screen and screen comprising such a matrix), and registered under number 02 15484. Such a matrix describes buses parallel to the rows, and disposed under each row of pixel electrodes, and used as storage capacitance. Such a matrix can even be used to produce a matrix according to the invention.

Such a matrix is illustrated in FIG. 5. It comprises storage capacitance buses provided under each row of pixel electrodes. Each pixel electrode EP_{i,j} covers a large portion of the area bracketed by two successive rows and columns. In the figure, the row Rᵢ of pixel electrodes is bracketed by the associated select row, rᵢ, and by the select row rᵢ₋₁ of the immediately preceding row.

For each row Rᵢ of pixel electrodes, an associated storage capacitance bus Bᵢ is provided under the row, roughly of the same width. This bus Bᵢ is disposed parallel, between the two select rows rᵢ and rᵢ₋₁. It is connected to the select row rᵢ₋₁ of the preceding row. In the example represented, it is connected to this row, outside the active area of the matrix, ZA, via its two ends.

This bus Bᵢ forms a storage capacitance Cst with each pixel electrode EP_{i,j} of the row Rᵢ.

In the invention, this storage capacitance formed by the bus Bᵢ, which is great, and which is connected to the preceding select row rᵢ₋₁, is advantageously used to charge the pixel electrodes EP_{i,j} of the row rᵢ to the required initialization voltage, typically to the initialization voltage Vreset. This is obtained by dimensioning the storage capacitance (area facing between the plane of the storage capacitance and the pixel electrode, dielectric used and thickness of the dielectric) so that the coupling offset is greater than the required initialization voltage.

Thus, the switching element T′ connected to the pixel electrode EP_{i,j} of FIG. 3a is here replaced in an equivalent manner by the bus Bᵢ. In fact, this bus forms a storage capacitance with this electrode EP_{i,j}, a terminal of this capacitance being connected to the pixel electrode, the other terminal of the capacitance being formed by the conductive bus itself and connected to the preceding row rᵢ₋₁. The switching on the line rᵢ₋₁, from the voltage Vg_{off} to the voltage Vgₒₙ results in the switching on the other terminal of the storage capacitance of a voltage equal to the coupling offset, approximately the voltage Vreset.

Thus, to return to FIG. 3b, on the preceding row time tlᵢ₋₁, the preceding row rᵢ₋₁ is at a level Vgₒₙ chosen to be greater than the initialization voltage Vreset. By coupling via the bus Bᵢ which is connected to the preceding row rᵢ₋₁, all the pixel electrodes of the row rᵢ are brought to the initialization voltage Vreset. The initialization circuit associated with each pixel electrode thus comprises the bus forming storage capacitance with said electrode.

Thus, more generally, according to an embodiment of the invention, the matrix comprises, for each row rᵢ, a conductive bus Bᵢ buried under the row of pixel electrodes of said row, and connected to the preceding row rᵢ₋₁. This bus forms a storage capacitance with each of the pixel electrodes of said row of rank i. This storage capacitance is dimensioned to exceed a coupling offset greater than the initialization voltage Vreset.

The initialization circuit associated with each pixel electrode then comprises the bus forming storage capacitance with said electrode.

The invention that has just been described can be used to apply to each pixel electrode an electrical signal shape with two stages: an initialization stage, for breaking, and a stage for writing the new video data item. The pixel electrode remains at the second stage until the next row time of the new video frame.

A refinement of the invention comprises a circuit for grounding the pixel electrodes of each row at the end of the row time.

There is then a signal shape on the pixel electrode with three stages: the stage corresponding to the anchoring breaking, the stage corresponding to the display of the new video data item (grey level) and the stage for return to ground. According to the abovementioned patent filed by Nemoptic, such a method of controlling the pixel electrodes offers better performance.

A first embodiment of a matrix according to the invention comprising such a grounding circuit is represented in FIG. 6a.

In this embodiment, the grounding circuit is another switching element, typically a transistor T″, connected between the pixel electrode EP_{i,j} and a ground plane GP of the matrix, and activated on the next row time tlᵢ₊₁. To this end, the gate g″ of this grounding transistor T″ is connected to the next row rᵢ₊₁.

As illustrated in FIG. 6b, the voltage level of the pixel electrode EP_{i,j} is pulled up on the row time tlᵢ₊₁, from the video level VDᵢ charged on the row time tlᵢ, to the electrical ground (0 volts).

There is a three-row-time operating mode, corresponding to the three voltage stages of the controlled signal on the pixel electrode EP_{i,j} of the row rᵢ;
The row time tlᵢ₋₁ corresponds to an initialization cycle τ_{c} of these pixel electrodes (for breaking anchoring).
The row time tlᵢ corresponds to a display cycle τᵥ of the new video on these pixel electrodes.
The row time tlᵢ₊₁ corresponds to a grounding cycle τₘ of these pixel electrodes.

From row to row, there thus follow in turn the three cycles τ_{c}, τᵥ, τₘ on three successive row times: the row time of the preceding row, the row time of the current row, the row time of the next row.

These row times are, in the example, immediately consecutive, a choice that facilitates the design, but it is perfectly possible for these row times to be separated by a number of row times.

FIG. 6a shows a control device with three transistors: the transistor T for charging the video, the transistor T′ for initialization and the transistor T″ for grounding. In the example, the grounding transistor is connected to a buried ground plane GP. This presupposes that the initialization transistor T′ is connected to a bus or a different conductive plane, which is itself brought to the voltage Vreset. In FIG. 6a, the voltage Vreset is thus brought by a Reset power supply bus, comprising conductors parallel to the columns (which corresponds to the embodiment of FIG. 3a). In FIG. 6c, the voltage Vreset is brought by a light shield LS type conductive plane (which corresponds to the embodiment explained with relation to FIG. 3d).

More generally, and as illustrated in FIG. 6d, the grounding transistor T″ is connected to a conductive functional layer F of the matrix, which is grounded.

The grounding circuit can even be produced by the row/pixel stray capacitance Cₚᵢₓₑₗ/rᵢ illustrated in FIG. 4a. To discharge the pixel electrode, the value of the capacitance is adapted to ensure at least the transition to the twist threshold voltage of the pixel when the row is deselected.

According to another embodiment, the grounding can be obtained by the natural play of leakage currents from the first switching element (T) and/or the second switching element of the control device of each pixel electrode, when these transistors are polycrystalline, monocrystalline, polymorphous or organic.

FIG. 7 illustrates another embodiment of a grounding circuit in a matrix according to the invention, according to which use is made of a leakage current from the spacers e normally used in the cavity comprising the liquid crystals of a display. According to the invention, there are one or more spacers on each electrode. These spacers are in contact with the pixel electrode and the counter-electrode CE. There is then a leakage current in each spacer which will pull the pixel electrode to the counter-electrode potential (typically ground). These spacers are made of a material chosen with a determined conductivity that is high enough not to disturb the charge of the pixel, but low enough to obtain the discharge after a few row times.

FIG. 8 illustrates yet another embodiment of the grounding circuit in a matrix according to the invention, with a matrix according to any one of the embodiments illustrated in FIGS. 3a, 3b, 3c, 3d, 4a or 5, or a variant thereof, in combination with an appropriate control of the power supplies on the column driver 4 at the end of each row time, that is, immediately before the end of the row time, because in this case, it is essential for the row to still be selected.

The grounding of the pixel electrodes of a row is thus obtained by controlling, on the columns, a return to zero at the end of each row time. Thus, on each row time, for example on the row time tlᵢ, there is, on each column, for example on the column colᵢ, first of all the video voltage level to be displayed VDᵢ, then the level 0. This can clearly be seen in FIG. 8. This is obtained by providing, in the column control circuit (column driver), or via a separate circuit controlled in an appropriate manner, for the grounding of the analogue voltages immediately before the end of each row time (the row must still be selected).

In practice, in the invention that has just been described, the transistors of the matrix T and T′ (or D) or T, T′ and T″ depending on the embodiment variants can be TFT transistors, the channel of which is made of amorphous silicon, and which offer the advantage of not being the source of leakage currents. This is an important parameter for TN or IPS displays.

For bistable nematic displays, where the nuisance of leakage currents does not apply, since the pixel retains the information indefinitely once the texture has been “written”, it is possible advantageously to use polycrystalline, microcrystalline, polymorphous or even organic type transistors. In this case, it has been seen how the grounding can even be obtained simply by the play of the leakage currents from the transistors T and/or T′ that will discharge the pixel electrode.

The different embodiments seen for the initialization circuit and the grounding circuit are combined together. The figures show some of these combinations by way of examples illustrating the invention. The invention is not limited to only these illustrated combinations but covers all the variants that devolve from them for those skilled in the art by applying their normal knowledge.

A bistable nematic display comprising an active matrix according to the invention with standard row or column drivers, integrated or otherwise, can thus be driven with row times of less than 40 microseconds, which means that it can be used for numerous applications, with all the advantages offered by the bistable nematic technology, and at lower cost.

In a liquid crystal display, the pixel electrode and the counter-electrode form the two armatures of the pixel capacitance, and the bistable material that is used to store the information is between the two armatures.

The invention that has just been described applies in an equivalent manner to matrix memory devices, with at least two stable states, such as ROM, RAM, CCD and other type memories, in which the bistable material is between the two armatures of the information storage capacitance. In this context, the pixel electrode should be understood to be an armature of this capacitance.

1-17. (canceled)

18. An active matrix for a liquid crystal display device, comprising:
pixel electrodes arranged in a crossed network of rows and columns; and
associated with each pixel electrode, an electronic control device comprising a first switching element connected between the pixel electrode and an associated column, a control electrode of the first switching element being connected to an associated row,
wherein the control device comprises a circuit for initializing the pixel electrode comprising a reset bus and a second switching element connected between the pixel electrode and the reset bus, a control electrode of which is connected to a preceding row of the network.

19. An active matrix according to claim 18, wherein the first and second switching elements of the electronic control device comprise transistors.

20. An active matrix according to claim 18, wherein the reset bus comprises a specific power supply bus.

21. An active matrix according to claim 20, wherein the power supply bus comprises a plurality of conductors disposed parallel to the columns or parallel to the rows.

22. An active matrix according to claim 20, wherein the power supply bus comprises a transparent or opaque functional conductive layer of the matrix, formed on a level separated from the pixel electrodes by at least one insulating layer.

23. An active matrix according to claim 18, comprising, for each row of rank i of the matrix, a conductive bus buried under the row of pixel electrodes of the row, and connected to a preceding row, the bus forming a storage capacitance with each of the pixel electrodes of the row of rank i, wherein the conductive bus forms the reset bus and the second switching element of the initialization circuit associated with each pixel electrode comprises the conductive bus forming storage capacitance with the electrode, a first terminal of the capacitance being connected to the pixel electrode, a second terminal of the capacitance being formed by the conductive bus, and connected to the preceding row.

24. An active matrix according to claim 18, wherein the second switching element comprises a diode.

25. An active matrix according to claim 24, wherein the diode is formed by a transistor, one conduction electrode, drain or source, of which is connected to the gate, the other conduction electrode being connected to the pixel electrode.

26. An active matrix according to claim 18, further comprising a grounding circuit of each pixel electrode.

27. An active matrix according to claim 26, further comprising a conductive functional layer, wherein the grounding circuit comprises a switching element connected between the pixel electrode and the functional layer, and a control electrode of which is connected to a next row in the matrix, the functional layer being grounded.

28. An active matrix according to claim 26, wherein the grounding circuit comprises a stray coupling capacitance between each pixel electrode and the associated row, capable of ensuring discharge of the pixel electrode when the row is deselected.

29. An active matrix according to claim 26, wherein the first switching element and/or the second switching element of the control device of each pixel electrode comprises a polycrystalline, monocrystalline, polymorphous or organic transistor.

30. A liquid crystal display comprising:
an active matrix according to claim 26, wherein the grounding circuit comprises spacers in a cavity containing liquid crystals, the spacers being placed on each pixel electrode, between each pixel electrode and a counter-electrode, and having a leakage current capable of discharging the pixel electrode over a few row times.

31. A liquid crystal display comprising:
an active matrix according to claim 18, comprising a row driver and a column driver configured to control the control circuit associated with each pixel electrode, the first switching element being activated by the row driver on an addressing time of the row, to apply a voltage level corresponding to a gray level to be displayed on the pixel electrode, the voltage level being applied to an associated column on the addressing time by the column driver, the second switching element being activated by the row driver on an addressing time of a preceding row, to apply an initialization voltage level.

32. A liquid crystal display comprising:
an active matrix according to claim 18, comprising a row driver and a column driver configured to control the control circuit associated with each pixel electrode, the first switching element being activated by the row driver on an addressing time of the row, to apply a voltage level corresponding to a gray level to be displayed on the pixel electrode, the voltage level being applied to an associated column on the addressing time by the column driver, the second switching element being activated by the row driver on an addressing time of a preceding row, to apply an initialization voltage level, and wherein the column driver pulls all the columns to ground at the end of each addressing time of a row, the row being still selected.

33. A display according to claim 31, of bistable nematic type.

34. A display according to claim 32, of bistable nematic type.
